(19) United States
(12) Patent Application Publication
(10) Pub. No.: US 2017/0342980 A1
(43) Pub. Date: Nov. 30, 2017

(54) ANTI-DECOMPRESSION GEAR FUEL PUMP FOR BROKEN BUBBLES

(71) Applicant: DONG WANG, BAODING (CN)

(72) Inventor: DONG WANG, BAODING (CN)

(21) Appl. No.: 15/168,230

(22) Filed: May 30, 2016

(51) Int. Cl. F04C 2/18; F04C 13/00; F04C 15/06; F02C 7/22; F04C 15/00; F02M 59/12

(52) U.S. Cl. CPC F04C 2/18; F04C 15/008; F02M 59/12; F04C 15/06; F02C 7/22; F04C 15/0073; F04C 13/001; F04C 2240/30; F04C 2240/60

(57) ABSTRACT

The present invention discloses an anti-decompression gear fuel pump for broken bubbles, characterized by comprising: a drive motor; and a pump body and a pump cover successively installed on the top end of the drive motor, wherein the pump body is provided with a groove, and a driving gear, a left driven gear and a right driven gear which are installed in the groove and are linked through a motor shaft of the drive motor; meanwhile, the driving gear is respectively internally engaged with the left driven gear and the right driven gear; the pump cover is provided with an A end of a fuel outlet, a D end of a circulating fuel outlet, a B end of a circulating fuel inlet, and a C end of a fuel inlet; and the A end of the fuel outlet, the D end of the circulating fuel outlet, the B end of the circulating fuel inlet, and the C end of the fuel inlet are penetrated into the groove of the pump body. The anti-decompression gear fuel pump for broken bubbles, designed in the present invention, not only solves a decompression problem generated because bubbles appear in a fuel pipeline, but also has scientific and reasonable structure.

### TECHNICAL FIELD

The present invention relates to the technical field of fuel pumps, and more particularly, relates to an anti-decompression gear fuel pump for broken bubbles.

### BACKGROUND

At present, a fuel pump of a jet engine, used in a traditional aircraft, may cause sudden decompression of the fuel pump when bubbles appear in a fuel pipeline, resulting in that fuel pressure is lower than the internal pressure of the engine, so fuel cannot enter the engine for internal combustion. In an instant, because the internal combustion of the engine stops, the aircraft instantaneously loses power and may fall. Meanwhile, a complex restart process and a low success rate of start bring unlimited annoyance for people, so people lose the fun of controlling a model airplane.

Therefore, how to provide a fuel pump which may not cause decompression even if bubbles appear in a fuel pipeline is a problem to be solved by those skilled in the art.

### SUMMARY

In view of this, the present invention provides an anti-decompression gear fuel pump for broken bubbles, which not only solves a decompression problem generated because bubbles appear in a fuel pipeline, but also has simple structure and scientific and reasonable design.

To achieve the above purpose, the present invention provides the following technical solution:

An anti-decompression gear fuel pump for broken bubbles comprises: a drive motor; and a pump body and a pump cover successively installed on the top end of the drive motor, wherein the pump body is provided with a groove, and a driving gear, a left driven gear and a right driven gear which are installed in the groove and are linked through a motor shaft of the drive motor; meanwhile, the driving gear is respectively internally engaged with the left driven gear and the right driven gear; the pump cover is provided with an A end of a fuel outlet, a D end of a circulating fuel outlet, a B end of a circulating fuel inlet, and a C end of a fuel inlet; and the A end of the fuel outlet, the D end of the circulating fuel outlet, the B end of the circulating fuel inlet, and the C end of the fuel inlet are penetrated into the groove of the pump body.

Preferably, in the above anti-decompression gear fuel pump for broken bubbles, the driving gear is formed by a gear and a gear shell and the driving gear is positioned in the center position of the pump body; and meanwhile, a driving gear shaft is arranged in the center position of the driving gear.

Preferably, in the above anti-decompression gear fuel pump for broken bubbles, the left driven gear and the right driven gear are respectively provided with a left driven gear shaft and a right driven gear shaft, and the left driven gear and the right driven gear are formed by the gear and the gear shell.

Preferably, in the above anti-decompression gear fuel pump for broken bubbles, the pump body and the pump cover are provided with screw installing holes in corresponding positions, and the pump body and the pump cover are closely connected through a screw.

Preferably, in the above anti-decompression gear fuel pump for broken bubbles, the D end of the circulating fuel outlet and the circulating fuel inlet are connected together through a circulating fuel storage pipe to form a circulating fuel storage loop.

It is known from the above technical solution that compared with the prior art, the present invention discloses and provides an anti-decompression gear fuel pump for broken bubbles, and has a working principle: when bubbles appear in the fuel pipeline or a section of gas enters the C end of the fuel inlet of the fuel pump, because the engaging end of the left driven gear and the driving gear rotates downwards and a separation space between two gears is expanded, negative pressure is generated for inhaling the bubbles which flow towards both sides under the guidance of teeth, wherein one side flows towards the A end of the fuel outlet and the other side flows towards the D end of the circulating fuel outlet. Meanwhile, because two gears of the D end of the circulating fuel outlet are engaged and rotated upwards to reduce the space there between, the bubbles guided by the teeth on the C end of the fuel inlet and circulating fuel guided by the teeth on the B end of the circulating fuel inlet are mixed and compressed into the circulating fuel storage pipe to flow towards the B end of the circulating fuel inlet. A part of the circulating fuel flowing towards the B end of the circulating fuel inlet is guided to and remixed with the D end of the circulating fuel outlet through the teeth of the right driven gear and the driving gear, and another part of fuel is guided to the A end of the fuel outlet and is mixed with the C end of the fuel inlet through the bubbles or fuel guided by the teeth. Because the engaging end of two gears on the A end of the fuel outlet is rotated downwards and compressed, the fuel is extruded from the A end of the fuel outlet; the bubbles on the C end of the fuel inlet enter the A end of the fuel outlet through the teeth; after being compressed, the gas is leaked back to the C end of the fuel inlet through a small gap between the gear and the gear shell, causing ultra-low pressure on the fuel outlet end, and is mixed with the B end of the circulating fuel inlet through the fuel guided by the teeth of the driving gear to form a mixed fuel-gas fluid; a gear gap between the A end of the fuel outlet and the C end of the fuel inlet is sealed through the sealing performance of the fuel so that the bubbles cannot be leaked back and extruded from the fuel pipe, thereby performing the function of preventing decompression of the fuel pump.

Therefore, the anti-decompression gear fuel pump for broken bubbles, designed in the present invention, not only solves a decompression problem generated because the bubbles appear in the fuel pipeline, but also has simple structure and scientific and reasonable design.

### DESCRIPTION OF THE DRAWINGS

To more clearly describe the technical solution in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is an exploded structural diagram of the present invention.

FIG. 2 is an inner structural diagram of a pump body of the present invention.

FIG. 3 is a schematic diagram of a movement direction of an inner fluid of a pump body of the present invention.

FIG. 4 is a structural diagram of a pump cover of the present invention.

FIG. 5 is a schematic diagram of a working principle of the present invention.

In FIG. 1:

1-drive motor; 2-pump body; 3-pump cover.

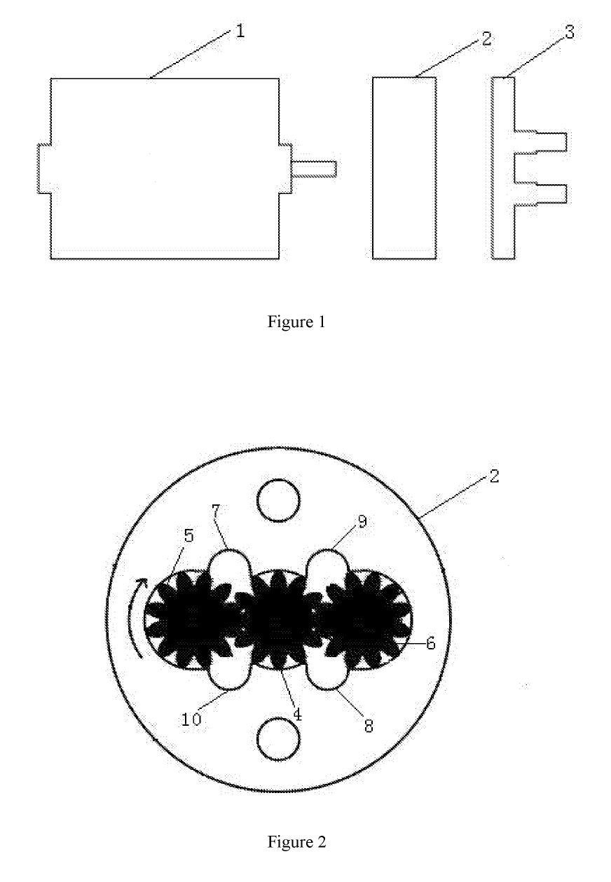

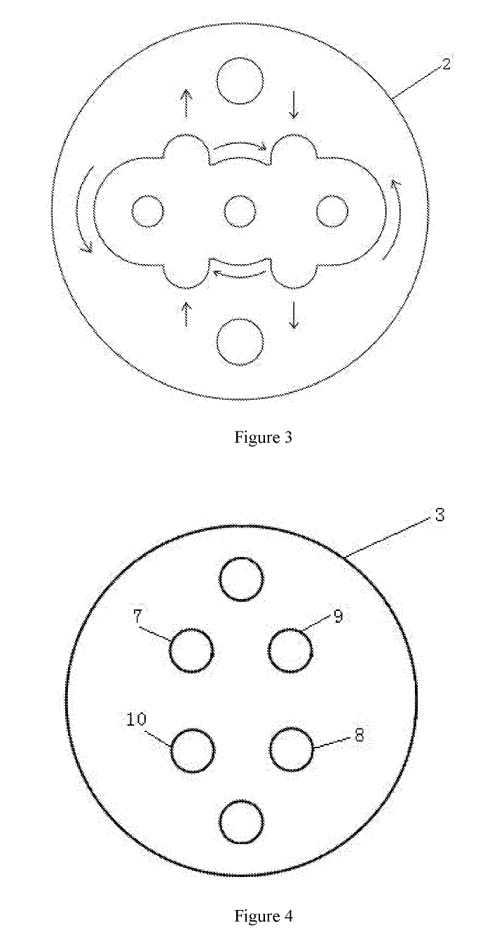

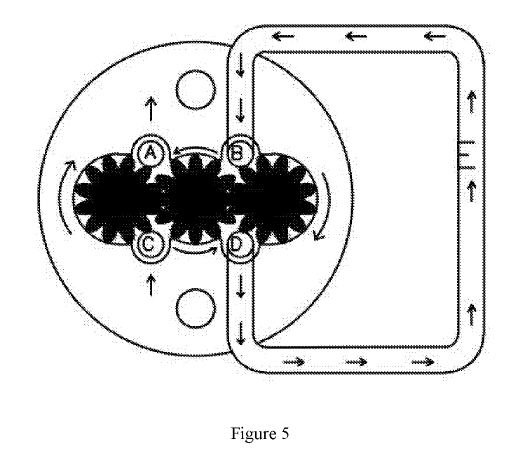

In FIG. 2:

2-pump body; 4-driving gear; 5-left driven gear; 6-right driven gear; 7-A end of a fuel outlet; 8-D end of a circulating fuel outlet; 9-B end of a circulating fuel inlet; 10-C end of a fuel inlet.

In FIG. 3:

2-pump body.

In FIG. 4:

3-pump cover; 7-A end of a fuel outlet; 8-D end of a circulating fuel outlet; 9-B end of a circulating fuel inlet; 10-C end of a fuel inlet.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

The embodiments of the present invention disclose an anti-decompression gear fuel pump for broken bubbles, which not only solves a decompression problem generated because the bubbles appear in the fuel pipeline, but also has scientific and reasonable structure and wide market prospect.

With reference to the related drawings, the present invention provides an anti-decompression gear fuel pump for broken bubbles, comprising: a drive motor 1; and a pump body 2 and a pump cover 3 successively installed on the top end of the drive motor 1, wherein the pump body 2 is provided with a groove, and a driving gear 4, a left driven gear 5 and a right driven gear 6 which are installed in the groove and are linked through a motor shaft of the drive motor 1; meanwhile, the driving gear 4 is respectively internally engaged with the left driven gear 5 and the right driven gear 6; the pump cover 3 is provided with an A end 7 of a fuel outlet, a D end 8 of a circulating fuel outlet, a B end 9 of a circulating fuel inlet, and a C end 10 of a fuel inlet; and the A end 7 of the fuel outlet, the D end 8 of the circulating fuel outlet, the B end 9 of the circulating fuel inlet, and the C end 10 of the fuel inlet are penetrated into the groove of the pump body 2.

To further optimize the above technical solution, the driving gear 4 is formed by a gear and a gear shell and the driving gear 4 is positioned in the center position of the pump body 2; and meanwhile, a driving gear shaft is arranged in the center position of the driving gear 4.

To further optimize the above technical solution, the left driven gear 5 and the right driven gear 6 are respectively provided with a left driven gear shaft and a right driven gear shaft, and the left driven gear 5 and the right driven gear 6 are formed by the gear and the gear shell.

To further optimize the above technical solution, the pump body 2 and the pump cover 3 are provided with screw installing holes in corresponding positions, and the pump body 2 and the pump cover 3 are closely connected through a screw.

To further optimize the above technical solution, the D end 8 of the circulating fuel outlet and the B end 9 of the circulating fuel inlet are connected together through a circulating fuel storage pipe to form a circulating fuel storage loop.

Each embodiment in the description is described in a progressive way. The difference of each embodiment from each other is the focus of explanation. The same and similar parts among all of the embodiments can be referred to each other. For a device disclosed by the embodiments, because the device corresponds to a method disclosed by the embodiments, the device is simply described. Refer to the description of the method part for the related part. The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

1. An anti-decompression gear fuel pump for broken bubbles, characterized by comprising: a drive motor (1); and a pump body (2) and a pump cover (3) successively installed on the top end of the drive motor (1), wherein the pump body (2) is provided with a groove, and a driving gear (4), a left driven gear (5) and a right driven gear (6) which are installed in the groove and are linked through a motor shaft of the drive motor (1); meanwhile, the driving gear (4) is respectively internally engaged with the left driven gear (5) and the right driven gear (6); the pump cover (3) is provided with an A end (7) of a fuel outlet, a D end (8) of a circulating fuel outlet, a B end (9) of a circulating fuel inlet, and a C end (10) of a fuel inlet; and the A end (7) of the fuel outlet, the D end (8) of the circulating fuel outlet, the B end (9) of the circulating fuel inlet, and the C end (10) of the fuel inlet are penetrated into the groove of the pump body (2).

2. The anti-decompression gear fuel pump for broken bubbles according to claim 1, characterized in that the driving gear (4) is formed by a gear and a gear shell and the driving gear (4) is positioned in the center position of the pump body (2); and meanwhile, a driving gear shaft is arranged in the center position of the driving gear (4).

3. The anti-decompression gear fuel pump for broken bubbles according to claim 1, characterized in that the left driven gear (5) and the right driven gear (6) are respectively provided with a left driven gear shaft and a right driven gear shaft, and the left driven gear (5) and the right driven gear (6) are formed by the gear and the gear shell.

4. The anti-decompression gear fuel pump for broken bubbles according to claim 1, characterized in that the pump body (2) and the pump cover (3) are provided with screw installing holes in corresponding positions, and the pump body (2) and the pump cover (3) are closely connected through a screw.

5. The anti-decompression gear fuel pump for broken bubbles according to claim 1, characterized in that the D end (8) of the circulating fuel outlet and the B end (9) of the circulating fuel inlet are connected together through a circulating fuel storage pipe to form a circulating fuel storage loop.
